(19) United States
(12) Patent Application Publication
(10) Pub. No.: US 2021/0285506 A1
(43) Pub. Date: Sep. 16, 2021

(54) CENTRIFUGAL CLUTCH FOR A DRIVETRAIN OF A MOTOR VEHICLE, HAVING BRAKED CENTRIFUGAL MASSES

(71) Applicant: Schaeffler Technologies AG & Co. KG, Herzogenaurach (DE)

(72) Inventor: Sebastian Heuberger, Bühl (DE)

(73) Assignee: Schaeffler Technologies AG & Co. KG, Herzogenaurach (DE)

(21) Appl. No.: 16/468,106

(22) PCT Filed: Jan. 17, 2018
(86) PCT No.: PCT/DE2018/100037

§ 371 Date: Jun. 10, 2019

(30) Foreign Application Priority Data
Feb. 16, 2017 (DE) 10 2017 103 108.1

(51) Int. Cl. F16D 43/10

(52) U.S. Cl. CPC F16D 43/10

(57) ABSTRACT

A centrifugal clutch includes an input part, an output part, a centrifugally engageable and disengageable friction unit, and a shifting apparatus. The friction unit has first frictional elements connected to the input part, and second frictional elements connected to the output part and layered alternately with the first frictional elements. The shifting apparatus is for frictionally engaging the first frictional elements and the second frictional elements to engage the clutch. The shifting apparatus has a centrifugal mass and a brake spring. When the centrifugal mass moves from a disengaged position to an engaged position, the brake spring is arranged to apply a first braking force contrary to a first direction of motion of the centrifugal mass. The brake spring is also arranged to apply a second braking force contrary to a second direction of motion of the centrifugal mass. The first braking force is greater than the second braking force.

### CROSS-REFERENCE TO RELATED APPLICATIONS

This application is the United States National Phase of PCT Appln. No. PCT/DE2018/100037 filed Jan. 17, 2018, which claims priority to German Application No. DE102017103108.1 filed Feb. 16, 2017, the entire disclosures of which are incorporated by reference herein.

### TECHNICAL FIELD

The present disclosure relates to a centrifugal clutch for a drivetrain of a motor vehicle. In motor vehicles such as motorcycles, light motorcycles or scooters, centrifugal clutches serve to equalize a drive unit speed and a transmission speed, in particular, during driving-off processes of the motor vehicle.

### BACKGROUND

Layered frictional elements that are connected in a rotationally locked manner to the input part and the output part of the centrifugal clutch are clamped under the effect of centrifugal force, so that a frictional engagement occurs between the input part and the output part when sufficient centrifugal force is present, and torque is transmitted. In the usual manner, the clamping of the frictional elements occurs through a centrifugal-force-dependent, radially outward movement of frictional masses positioned between a ramp system, so that a plate part pre-tensions the frictional elements directly or indirectly against the effect of a spring, so that as the radially outward movement of the centrifugal bodies increases, the frictional engagement increases, for example during a driving-off process as the rotational speed of the input part increases, and successive torque is transmitted from the input part to the output part.

Such centrifugal clutches may be combined with an automated transmission, for example a continuously variable transmission (CVT). From WO 2015/135540 A1, for example, a centrifugal clutch is known which has a shifting apparatus that engages and disengages depending on centrifugal force, and in addition has a release mechanism operable by the driver, as a shifting clutch. The release mechanism operable by the driver disengages and engages the engaged clutch against the centrifugal force. In this case, the centrifugal clutch, which is engaged by the shifting apparatus depending on the centrifugal force, engages under the influence of the centrifugal force only at comparatively high rotational speeds of the drive unit, to be able to provide the required starting torque. However, as rotational speeds decrease, this causes the centrifugal clutch to disengage already at comparatively high rotational speeds, so that at low rotational speeds above the idling speed of the drive unit no torque is available from the drive unit while the motor vehicle is still moving.

Centrifugal clutches are therefore also known whose output part has a second centrifugally engaging and disengaging apparatus. This enables both starting to drive the motor vehicle with the drive unit at a high speed, as well as driving at low rotational speeds, for example under partial load, since disengagement of the centrifugal clutch due to centrifugal force does not occur until lower rotational speeds are reached. To this end, the input part has, in a known manner, a first (drive-side) centrifugally engaging and disengaging apparatus, and in addition the output part has a second (transmission-side) centrifugally engaging and disengaging apparatus. Both centrifugally shifting engaging and disengaging apparatuses apply an axial force to the frictional elements to form a frictional engagement. This means that as the rotational speeds of the input part and the output part increase, that is, when the motor vehicle is moving, the centrifugal clutch is engaged centrifugally, i.e., depending on the rotational speed of the drive unit and the transmission, until the friction clutch is disengaged again, for example when the drive unit is at idling speed and the motor vehicle is essentially standing still.

With the motor vehicle at rest, the centrifugal clutch can therefore not be engaged until comparatively high rotational speeds are reached, and thus there is sufficient power for a speedy driving-off process. Due to the additional load imposed on the frictional elements by the second (transmission-side) shifting apparatus when the motor vehicle is moving, during the driving-off process the centrifugal clutch remains engaged until rotational speeds below the coupling speed are reached, or at least still transmits torque in a slipping mode. However, a disadvantage of such centrifugal clutches is its great need for axial construction space, its increased weight, and its high assembly cost due to the large number of individual parts.

### SUMMARY

The centrifugal clutch according to the disclosure for a drivetrain of a motor vehicle has an input part, an output part which is positioned coaxially and rotatably in relation to the input part, and a centrifugally engageable and disengageable friction unit. The friction unit includes first frictional elements that are connected non-rotatingly to the input part and second frictional elements that are connected non-rotatingly to the output part, which are layered alternately in an axial direction and which may be brought into frictional engagement by means of at least one centrifugally engaging and disengaging shifting apparatus to engage the centrifugal clutch. The at least one centrifugally engageable and disengageable shifting apparatus includes at least one centrifugal mass, which is movable from a disengaged position to an engaged position by a centrifugal force that occurs when the at least one centrifugally engaging and disengaging shifting apparatus rotates.

The at least one centrifugal mass, when it moves from the disengaged position to the engaged position, is subjected in a first range of motion to a first braking force by at least one brake spring contrary to a direction of motion of the at least one centrifugal mass, and is subjected in a second range of motion to a second braking force by the at least one brake spring contrary to the direction of motion of the at least one centrifugal mass. The first braking force is greater than the second braking force.

The proposed friction clutch is intended for a drivetrain of a motor vehicle, for example a motorcycle, light motorcycle, scooter, light scooter, passenger car or the like. Such motor vehicles normally have a drive unit, for example a combustion engine, and a transmission. The transmission may be designed, for example, in the nature of a transmission with endless torque-transmitting means (CVT, continuously variable transmission), an automatic transmission, or a shift transmission shifted manually by a driver.

The friction clutch includes a drive-side input part which is positioned so that it is rotatable around an axis of rotation by means of the drive unit. It is connectable directly or indirectly, for example, to a crankshaft of the drive unit. Furthermore, the centrifugal clutch includes an output part which is positioned coaxially and rotatably in relation to the input part, which is connectable indirectly or directly, for example, to a transmission input shaft of the transmission. Provided between the input part and the output part is a friction unit which operates in the circumferential directions and is centrifugally engageable and disengageable.

The friction unit includes first frictional elements which are connected non-rotatingly to the input part, and second friction elements which are connected to the output part, in particular, to a leaf spring core of the output part, which may be layered alternately in an axial direction and may be brought into frictional engagement with at least one centrifugally engaging and disengaging shifting apparatus to engage the centrifugal clutch. The first frictional elements and/or the second frictional elements are, in particular, ring-shaped, and/or are made at least partially of metal. Furthermore, the first frictional elements and/or the second frictional elements have friction linings. The first frictional elements and the second frictional elements are clampable in the axial direction, in particular, between a counter-pressure plate and, for example, a contact plate of the leaf spring ring or of a pressure ring of an inner plate carrier.

The at least one centrifugally engaging and disengaging shifting apparatus is, in particular, connected non-rotatingly to the input part, and has at least one centrifugal mass. It must be clarified that the centrifugal clutch, in particular, has only a single centrifugally engaging and disengaging shifting apparatus. By means of the at least one centrifugally engaging and disengaging shifting apparatus, the first frictional elements and second frictional elements of the friction unit may be subjected to a clamping force in an axial direction to form a frictional engagement. This means that as the rotational speed of the input part increases, the centrifugal clutch is or remains engaged centrifugally, i.e., depending on the rotational speed of the drive, until the centrifugal clutch is disengaged again, for example when the drive is at idling speed and the motor vehicle is essentially standing still.

The at least one centrifugal mass of the at least one centrifugally engaging and disengaging shifting apparatus is movable in a radial direction, that is, in particular, orthogonally to the axis of rotation of the at least one centrifugally engaging and disengaging shifting apparatus, between an open position, in which the centrifugal clutch is disengaged, and a closed position, in which the centrifugal clutch is engaged. Here, the at least one centrifugal mass is movable from the disengaged position to the engaged position by a centrifugal force that arises in a rotation of the at least one centrifugally engaging and disengaging shifting apparatus.

In the disengaged position, the at least one centrifugal mass is, in particular, maximally inside in the radial direction, and/or maximally outside in the radial direction in the engaged position. When the at least one centrifugal mass moves from the disengaged position to the engaged position, the at least one centrifugal mass first moves in a first motion range, in which the at least one centrifugal mass is subjected by at least one brake spring to at least one braking force contrary to a direction of motion of the at least one centrifugal mass. (Directly) adjacent to the first motion range outward in the radial direction is a second motion range of the at least one centrifugal mass, in which the at least one centrifugal mass is subjected by the at least one brake spring to a second braking force contrary to the direction of motion of the at least one centrifugal mass.

The first braking force is greater than the second braking force. This means, in particular, that the at least one brake spring has a first braking stage with a higher braking force, for example for a driving-off process of the motor vehicle, and a second stage with a lower braking force, for example for driving operation of the motor vehicle. With the motor vehicle at rest, the centrifugal clutch can therefore not be engaged until comparatively high rotational speeds are reached, and thus there is sufficient driving power for a speedy driving-off process.

Due to the lesser second braking force of the at least one brake spring in the second motion range, during the driving-off process the centrifugal clutch remains engaged until rotational speeds below the coupling speed are reached, or at least still transmits torque in a slipping mode. This design makes it possible to dispense with a second centrifugally engaging and disengaging shifting apparatus connected non-rotatingly to the output part, so that the required axial construction space, the weight of the centrifugal clutch and the assembly and installation cost of the centrifugal clutch is reduced.

Furthermore, the at least one brake spring may be designed in the nature of a diaphragm spring. The at least one brake spring is, in particular, (substantially) ring-shaped and/or made of metal.

Furthermore, the at least one brake spring may have at least one spring arm. The at least one spring arm may, in particular, be formed on an outer circumferential surface of the at least one brake spring. Furthermore, the at least one spring arm may be bent at least partially in a U-shape or V-shape.

Additionally, the at least one brake spring may have a plurality of spring arms, which are arranged in V-shaped pairs. Each of the individual spring arms of the paired spring arms arranged in a V-shape relative to each other may subject a centrifugal mass to a braking force, which are arranged, for example, adjacent to each other in a circumferential direction.

In addition, the at least one centrifugal mass may have at least one oblique first contact surface on which the at least one brake spring contacts the at least one centrifugal mass in the first motion range. Here, oblique is understood to mean that the first contact surface does not run orthogonally to the axis of rotation of the at least one centrifugally engaging and disengaging shifting apparatus. The at least one oblique first contact surface may be formed, for example, as a recess at a radially outer end of the at least one centrifugal mass. In particular, the at least one centrifugal mass has two oblique first contact surfaces, which are formed at two ends of the at least one centrifugal mass, which are opposite each other in a rotational direction.

In addition, the at least one centrifugal mass may have at least one second contact surface, on which the at least one brake spring contacts the at least one centrifugal mass in the second motion range. The at least one second contact surface is, in particular, a face of the at least one centrifugal mass in a longitudinal direction parallel to the axis of rotation of the at least one centrifugally engaging and disengaging shifting apparatus, and/or a surface running parallel to the axis of rotation of the at least one centrifugally engaging and disengaging shifting apparatus. In the second motion range of the at least one centrifugal mass, the at least one brake spring introduces merely a normal force into the at least one centrifugal mass, that is, a force perpendicular to the at least one second contact surface and/or in the longitudinal direction. The second braking force is thus, in particular, (exclusively) a friction force between the at least one centrifugal mass and the at least one brake spring, resulting from the normal force.

The first contact surface and the second contact surface may not run parallel to each other. This ensures that the first braking force and the second braking force are not equal.

The at least one centrifugal mass may have at least one oblique third contact surface, by means of which the one angle plate of the at least one centrifugally engaging and disengaging shifting apparatus may be moved. The angle plate has at least one ramp, by means of which the angle plate may be moved in the longitudinal direction by the at least one centrifugal mass. By moving the angle plate in the longitudinal direction, the first frictional elements and second frictional elements are brought into frictional engagement with each other, so that torque is transmissible from the input part to the output part.

In addition, the angle plate may have at least one opening, through which the at least one brake spring extends at least partway.

Furthermore, a pivot bearing may be positioned between the at least one centrifugally engaging and disengaging shifting apparatus and a leaf spring core of the centrifugal clutch. The leaf spring core is, in particular, part of the output part, and includes, in particular, a hub and a contact plate. By means of the hub, the leaf spring core is, in particular, attachable non-rotatingly to a transmission input shaft of a transmission. The second frictional elements are, in particular, connected non-rotatingly to the hub and/or the contact plate. By means of leaf springs, the hub and the contact plate are connected to each other non-rotatingly and are movable relative to each other in the longitudinal direction to a limited extent. The pivot bearing is, in particular, a needle bearing and/or thrust bearing, by means of which a difference in speed of rotation between the input part and the output part may be compensated for. During the repositioning of the contact plate in an axial direction by the angle plate as the centrifugal clutch is engaged, the leaf spring core is rotated by some degrees around the axis of rotation; this rotation of the leaf spring core may also be compensated for by the pivot bearing.

### BRIEF DESCRIPTION OF THE DRAWINGS

The disclosure as well as the technical environment will be explained in greater detail below on the basis of the figures. It must be pointed out that the figures show an example variant of the invention, but the disclosure is not limited thereto. Like components in the figures are provided with the same reference labels. The figures show the following, by way of example and schematically:

FIG. 1 shows a centrifugal clutch in longitudinal section;

FIG. 2 shows a centrifugally engageable and disengageable shifting apparatus of the centrifugal clutch in top view;

FIG. 3 shows a centrifugally engageable and disengageable shifting apparatus without an angle plate in top view;

FIG. 4 shows a partial view of FIG. 3 in a perspective view;

FIG. 5 shows a sectional view of a centrifugal mass of the centrifugal clutch in a disengaged position;

FIG. 6 shows a sectional view of the centrifugal mass of the centrifugal clutch in an engaged position;

FIG. 7 shows a brake spring of the centrifugal clutch in a perspective view; and

FIG. 8 shows a diagram of the clamping force of a friction unit of the centrifugal clutch depending on the speed of rotation of an input part of the centrifugal clutch.

### DETAILED DESCRIPTION

FIG. 1 shows a sectional view of a centrifugal clutch 1 in longitudinal section. The centrifugal clutch 1 has an input part 2 having an input plate 23 that is rotatable around an axis of rotation 26 by a drive unit (not shown here), and an outer plate carrier 24 attached non-rotatingly to the input plate 23. Connected non-rotatingly to the outer plate carrier 24 of the input part 2 are first frictional elements 5 of a friction unit 4. The friction unit 4 has, in addition, second frictional elements 6, which are attached non-rotatingly to a hub 27 and a contact plate 29 of a leaf spring core 21. The hub 27 has toothing 28, by means of which the hub 27 is connectable non-rotatingly to a transmission shaft of a transmission (not shown here). The contact plate 29 is attached non-rotatingly to the hub 27 by means of leaf springs 44, and is movable to a limited extent in an axial direction 7 parallel to the axis of rotation 26. The leaf spring core 21 is part of an output part 3 of the centrifugal clutch 1. When the centrifugal clutch 1 is in a disengaged state, the output part 3 is (essentially) freely rotatable around the axis of rotation 26 relative to the input part 2.

The input part 2 has a centrifugally engaging and disengaging shifting apparatus which is rotatable with the input part 2. The shifting apparatus 8 is fastened non-rotatingly to the input plate 23 of the input part 2 by means of bolts 32. The shifting device 8 includes centrifugal masses 9, which here are in a disengaged position 10, that is, maximally to the inside in a radial direction 25. When the input part 2 rotates, the centrifugal masses 9 are moved outward in the radial direction 25 by centrifugal force. As this occurs, an oblique third contact surface 18 of the centrifugal masses 9 contacts ramps 31 of an angle plate 19 of the shifting apparatus 8, which causes the angle plate 19 to be moved in the axial direction 7 in the direction of the leaf spring core 21. The angle plate 19 thereby moves the contact plate 29, so that the first frictional elements 5 and the second frictional elements 6 are clamped between the contact plate 29 and a counter-pressure plate 30 and brought into frictional engagement, so that torque is transmissible from the input part 2 to the output part 3. To this end, a pivot bearing 22, which is formed here in the nature of a needle bearing, is positioned between the angle plate 19 and a support 45 of the leaf spring core 21. Furthermore, a brake spring 13 is positioned between the angle plate 19 and the centrifugal masses 9 in the axial direction 7.

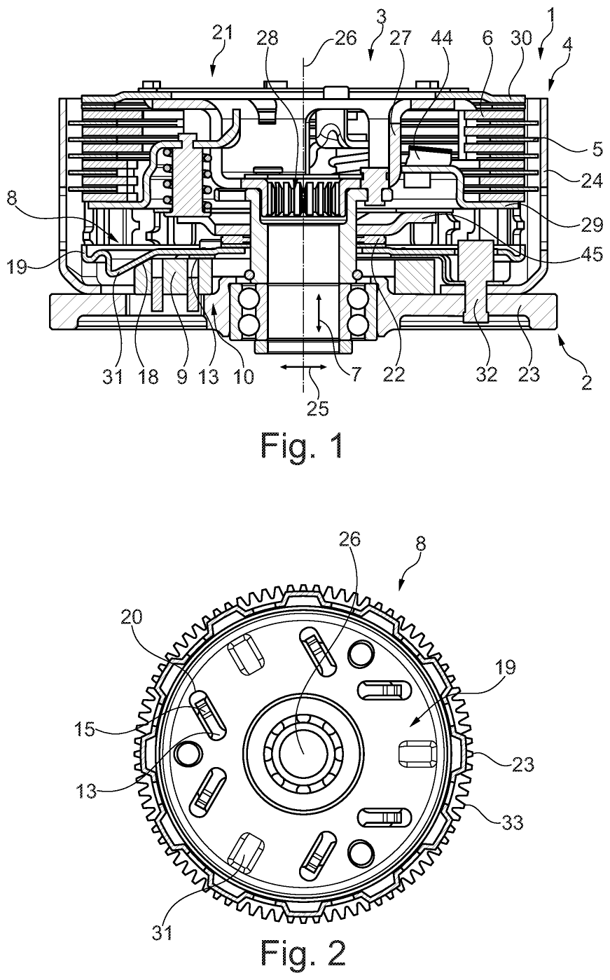

FIG. 2 shows the shifting apparatus 8 of the centrifugal clutch 1 shown in FIG. 1, from above in the direction of the axis of rotation 26. The angle plate 19 in the variant shown here has six openings 20, through each of which a spring arm 15 of the brake spring 13 extends at least partway. Also evident in FIG. 2 is that the angle plate 19 in the variant shown here has three ramps for the centrifugal masses 9 shown in FIG. 1. Furthermore, the input plate 23 has external toothing 33 on its outer circumferential surface, by means of which the input plate 23 is rotatable around the axis of rotation 26 by a drive unit (not shown here).

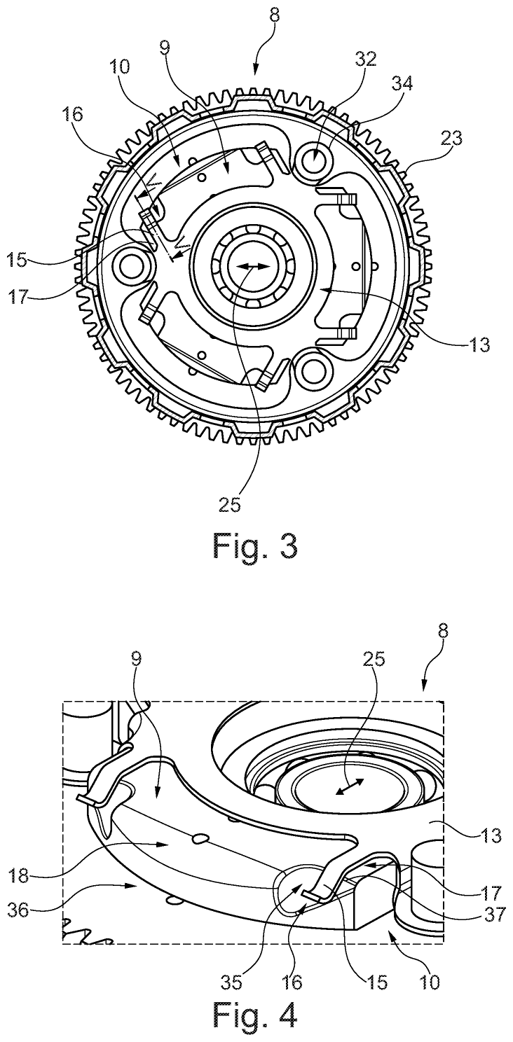

FIG. 3 shows the shifting apparatus 8 without the angle plate 19 shown in FIG. 2. Particularly evident here is the brake spring 13, which has six spring arms 15 arranged in V-shaped pairs on an outer circumferential surface. In addition, the brake spring 13 has three plate-links 34, by means of which the brake spring 13 is fastened non-rotatingly on the input plate 23 with the bolts 32. The three centrifugal masses 9 are in the disengaged position 10 here. In the disengaged position 10, the spring arms 15 contact the centrifugal masses 9 on an oblique first contact surface 16. When the shifting apparatus 8 rotates, the centrifugal masses 9 are moved outward in the radial direction 25 by the centrifugal force, so that the spring arms 15 slide over the first oblique contact surfaces 16 in the direction of a second contact surface 17 of the centrifugal masses 9. As this occurs, the spring arms 15 of the brake spring 13 introduce a first braking force through the oblique first contact surface 16 into the centrifugal masses 9 against the movement direction of the centrifugal masses 9. After the second contact surface 17 has been reached, the spring arms 15 of the brake spring 13 introduce a second braking force that is smaller than the first braking force into the centrifugal masses 9, against the movement direction of the centrifugal masses 9.

FIG. 4 shows a detail of the shifting apparatus 8 shown in FIG. 3 in a perspective view. Recognizable here are, in particular, the first contact surfaces 16 of the centrifugal mass 9, which is in the disengaged position. The first contact surfaces 16 here are in the form of recesses 35, and run obliquely or at an angle to the radial direction 25. Additionally, the first two contact surfaces 16 are formed at a radially outer end 26 of the centrifugal masses 9. Also formed on this radially outer end 26 is the third contact surface 18, by means of which the centrifugal masses 9 move the angle plate 19. It must be clarified here that the first contact surfaces 16 and the third contact surfaces 18 may also be formed as a single contiguous oblique contact surface. In the area of the first contact surface 16, the spring arms 15 are bent in a U-shape or V-shape. When the centrifugal masses 9 are moved outward in the radial direction 25 as a result of the centrifugal force, the U-shaped or V-shaped areas of the spring arms 15 of the brake spring 13 contact the centrifugal masses 9 (only) on the second contact surface 17, which is oriented orthogonally to the axis of rotation 26 shown in FIG. 2.

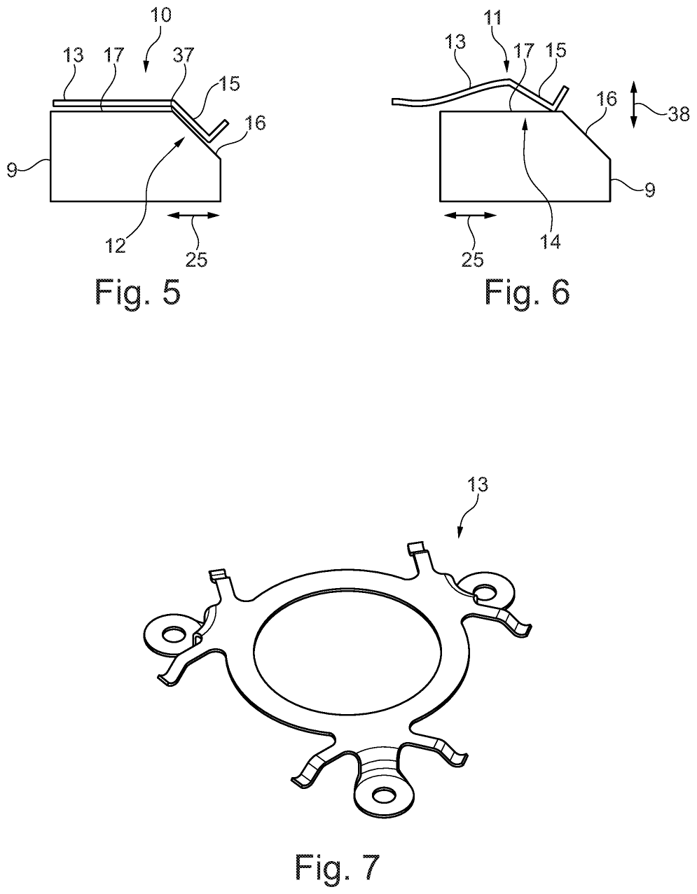

FIG. 5 shows a schematic sectional view along the cutting line V shown in FIG. 3, through one of the centrifugal masses 9. Here, the centrifugal mass 9 is in the disengaged position 10 and in the first motion range 12. In the first motion range 12 the spring arms 15 of the brake spring 13 contact the centrifugal masses 9 (only) on the first contact surface 16, so that the brake spring 13 introduces a first braking force inward in the direction of the radial direction 25. The first motion range 12 of the centrifugal masses 9 extends outward in the radial direction 25 from the disengaged position 10 shown here, until the brake spring 13 no longer contacts the centrifugal masses 9 on the oblique contact surface 16, but now only in the area of a boundary 37 between the first contact surface 16 and the second contact surface 17.

FIG. 6 shows the sectional view shown in FIG. 5, after the centrifugal mass 9 has been moved outward maximally in the radial direction 25. Here, the centrifugal mass 9 is thus in the engaged position 11 or in the second motion range 14. In the second motion range 14, the spring arms 15 of the brake spring 13 no longer contact the centrifugal mass 9 in the area of the first contact surface 16, but rather now only on the second contact surface 17. In the second motion range 14, the brake spring 13 introduces a normal force into the centrifugal mass 9 in the longitudinal direction 38, which, contrary to the direction of motion of the centrifugal mass 9 in the radial direction 25 in the form of a friction force resulting from the normal force, causes a second braking force which is smaller than the first braking force.

FIG. 7 shows a perspective view of the brake spring 13.

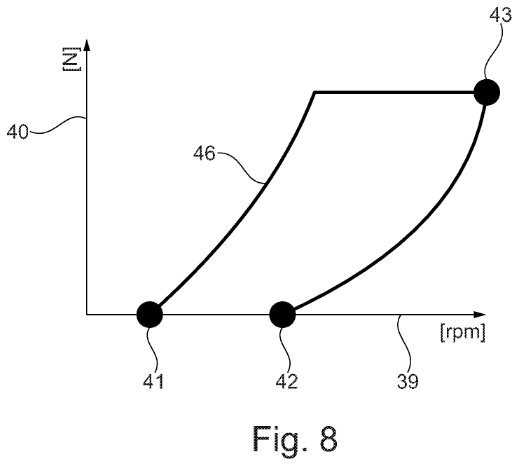

FIG. 8 shows the pattern of a clamping force 46 of the friction unit 4 shown in FIG. 1, between a driving-off process of a motor vehicle (not shown here) and a subsequent standstill of the motor vehicle. A speed in revolutions per minute [rpm] of a drive unit of the motor vehicle (not shown here) is plotted on an x-axis 39, and the level in Newtons [N] of the clamping force 46 acting on the friction unit 4 is plotted on a y-axis. At a first point 41, before the vehicle begins to move, the clamping force is essentially 0 N. At the second point 42, the rotational speed of the drive unit or of the input part is increased to a driving-off speed. Because of the first braking force then introduced by the brake spring 13 onto the centrifugal masses 9 contrary to the direction of motion of the centrifugal masses 9, the clamping force 46 essentially does not increase between the first point 41 and the second point 42. Only when the rotational speed of the drive or of the input part increases further is the clamping force 46 increased, until a maximum value of the clamping force 46 is reached at a third point 43.

At the third point 43, the centrifugal masses 9 are in the engaged position 11 or in the second motion range 14, so that the brake spring 13 now acts on the centrifugal masses 9 contrary to the movement direction of the centrifugal masses only with a smaller braking force, compared to the first braking force. When the rotational speed of the drive is reduced starting from the third point 43, the clamping force 46 is always greater than 0 N, so that until the first point 41 is reached, that is, the idle speed of the drive, torque is transmissible from the input part 2 to the output part 3.

The present disclosure is distinguished by a smaller construction space requirement, a lower weight and a lower assembly and installation cost.

### REFERENCE NUMERALS

1 centrifugal clutch

2 input part

3 output part

4 friction unit

5 first frictional elements

6 second frictional elements

7 axial direction

8 shifting apparatus

9 centrifugal mass

10 disengaged position

11 engaged position

12 first motion range

13 brake spring

14 second motion range

15 spring arm

16 first contact surface

17 second contact surface

18 third contact surface

19 angle plate

20 opening

21 leaf spring core

22 pivot bearing

23 input plate

24 outer plate carrier

25 radial direction

26 axis of rotation

27 hub

28 toothing

29 contact plate

30 counter-pressure plate

31 ramp

32 bolt

33 external toothing

34 strap

35 recess

36 end

37 boundary

38 longitudinal direction

39 x-axis

40 y-axis

41 first point

42 second point

43 third point

44 leaf spring

45 support

46 clamping force

1.-10. (canceled)

11. A centrifugal clutch for a drivetrain of a motor vehicle comprising:
an input part;
an output part positioned coaxially and rotatably in relation to the input part;
a centrifugally engageable and disengageable friction unit comprising:
first frictional elements connected non-rotatingly to the input part; and,
second frictional elements connected non-rotatingly to the output part and layered alternately with the first frictional elements in an axial direction; and,
a shifting apparatus for frictionally engaging the first frictional elements and the second frictional elements to engage the centrifugal clutch, comprising:
a centrifugal mass movable from a disengaged position to an engaged position by a centrifugal force that occurs when the shifting apparatus rotates; and,
a brake spring, wherein:
when the centrifugal mass moves from the disengaged position to the engaged position, the brake spring is arranged to apply a first braking force to the centrifugal mass in a direction contrary to a first direction of motion of the centrifugal mass;
the brake spring is arranged to apply a second braking force to the centrifugal mass, contrary to a second direction of motion of the centrifugal mass; and,
the first braking force is greater than the second braking force.

12. The centrifugal clutch of claim 11, wherein the brake spring is a diaphragm spring.

13. The centrifugal clutch of claim 11, wherein the brake spring comprises a spring arm.

14. The centrifugal clutch of claim 13, wherein the brake spring comprises a plurality of spring arms arranged in V-shaped pairs.

15. The centrifugal clutch of claim 11, wherein:
the centrifugal mass comprises a first contact surface; and,
the brake spring for contacting the first contact surface to apply the first braking force.

16. The centrifugal clutch of claim 15, wherein:
the centrifugal mass comprises a second contact surface; and,
the brake spring is arranged to contact the second contact surface to apply the second braking force.

17. The centrifugal clutch of claim 16, wherein the first contact surface and the second contact surface are not parallel.

18. The centrifugal clutch of claim 11, wherein:
the shifting apparatus comprises an angle plate; and,
the centrifugal mass comprises a third contact surface for moving the angle plate.

19. The centrifugal clutch of claim 18, wherein:
the angle plate comprises an opening; and,
the brake spring extends at least partway through the opening.

20. The centrifugal clutch of claim 11, further comprising:
a leaf spring core; and,
a pivot bearing positioned between the shifting apparatus and the leaf spring core.
